(19) United States
(12) Patent Application Publication
(10) Pub. No.: US 2006/0289489 A1
(43) Pub. Date: Dec. 28, 2006

(54) Induction cooktop with remote power electronics

(76) Inventor: Dongyu Wang, Blacksburg, VA (US)

Correspondence Address: MACPHERSON KWOK CHEN & HEID LLP, 2033 GATEWAY PLACE, SUITE 400, SAN JOSE, CA, 95110, US

(21) Appl. No.: 11/431,800

(22) Filed: May 9, 2006

Related U.S. Application Data
(60) Provisional application No. 60/679,461, filed on May 9, 2005.

(51) Int. Cl. H05B 6/12

(52) U.S. Cl. 219/622

(57) ABSTRACT

A range having an induction cooktop and a conventional oven is disclosed. The power electronics of the induction cooktop can be located remotely with respect to the induction elements such that detrimental effects caused by heat from the oven are mitigated and any service work required greatly simplified. A fan for the power electronics of the induction cooktop can be controlled in a manner that mitigates undesirable noise. Objectionable beat frequencies between two operating induction coils of the cooktop can be mitigated. A single inverter can be used to power multiple induction coils via the use of a switching relay. Thus, a more reliable, less costly, and more user friendly induction cooker can be provided.

### PRIORITY CLAIM

This patent application claims the benefit of the priority date of U.S. provisional patent application Ser. No. 60/679,461, filed on May 9, 2005 and entitled INDUCTION COOKTOP ON RANGE OVEN WITH REMOTE POWER ELECTRONICS AND NOISE REDUCTION (docket no. M-15937-V1 US) pursuant to 35 USC 119. The entire contents of this provisional patent application are hereby expressly incorporated by reference.

### TECHNICAL FIELD

The present invention relates generally to induction heating. The present invention relates more particularly to an induction cooktop on a range oven having remote power electronics, as well as other features for noise reduction and enhanced performance which are applicable to counter-top, drop-in and built-in induction ranges.

### BACKGROUND

The use of induction heating for cooking is a well established practice. More particularly, induction ranges have been in use for many years and are presently being manufactured by several different companies.

The circuitry and coil design for contemporary induction ranges has, to date, concentrated primarily upon the basic electronics necessary for making induction heating work on a fundamental level. Moreover, the reliability and user friendliness of contemporary induction ranges is undesirability limited and any required service is difficult to perform due to the inaccessibility of the power electronics under the ceramic glass top in standard cooktops.

For example, contemporary induction ranges are designed as an assembly that can be placed atop a conventional oven. The assembly includes both the induction coils and the power electronics, e.g., the inverter, needed to drive the induction coils. Although such construction does provide cost and assembly advantages, it also suffer from some disadvantages that tend to reduce its reliability and user friendliness.

Placing the induction cooktop's power electronics atop the oven undesirably exposes the power electronics to excessive heat. This is particularly true when the oven has a self-cleaning feature that uses higher heat than that used for cooking. Such heat, particularly over time, can damage or destroy the induction cooktop's power electronics. Indeed, during the self-cleaning cycle of the conventional oven, the induction cooktop cannot be used because the excessive heat could harm the induction cooktop's power electronics.

Further, the power electronics of contemporary induction cooktops have fans that prevent the inverter from overheating. Such fans can produce substantial noise. This noise can be distracting and irritating, and is thus undesirable.

In view of the foregoing, it is desirable to provide an improved induction cooktop that is less susceptible to heat from the oven than contemporary induction cooktops and that produces substantially less noise than contemporary induction cooktops. Such an improved induction cooktop would have enhanced reliability and user friendliness.

### BRIEF SUMMARY

An improved cooktop/oven combination that can define a range is disclosed. According to one embodiment of the present invention, the cooktop/oven combination can comprise an oven, an induction cooktop comprised of one or several energizing work coils (induction coils) which create the magnetic field that then passes through the glass top and heats a pan made of a ferrous material, disposed atop the oven, and power electronics for the induction cooktop. The power electronic can comprise at least one inverter. The power electronics can be disposed remotely with respect to the induction cooktop and the energizing work coils. Thermal insulation can be provided between the oven and the power electronics.

In this manner, the power electronics can be thermally isolated, at least to some degree, from the oven. Thermal isolation of the power electronics from the oven mitigates the likelihood of damage to the power electronics caused by heat from the oven. It can also facilitate operation of the induction cooktop while the oven is in a self-cleaning cycle.

According to one embodiment of the present invention, a fan of the power electronics is not turned on when the induction range is first turned on. The fan can be turned on after a predetermined time or when the power electronics, or other internal temperature sensor reaches a predetermined temperature.

According to one embodiment of the present invention, a method for operating an induction cooker that has a plurality of induction elements comprises controlling the operating frequency of each induction element in a manner such that the cooking frequencies are separately by an amount that substantially mitigates audible beat frequencies.

According to one embodiment of the present invention, an induction cooker comprises at least two induction elements and an inverter. The inverter is configured to provide electrical power to at least two of the induction elements.

Thus, an induction cooker is provided that has enhanced reliability, reduced noise, and lower cost when compared to contemporary induction cookers.

This invention will be more fully understood in conjunction with the following detailed description taken together with the following drawings.

### BRIEF DESCRIPTION OF THE DRAWINGS

FIG. 1 is a semi-schematic front view of an exemplary induction cooktop, which can be comprised of a ceramic glass top or other suitable material and energizing work coils, one or more thermal sensors and one or more indicators and displays, on a range oven, wherein the induction cooktop has remote power electronics located beneath the oven, according to a first embodiment of the present invention;

FIG. 2 is a semi-schematic front view of an exemplary induction cooktop on a range oven, wherein the induction cooktop has remote power electronics located beside the oven, according to a second embodiment of the present invention;

FIG. 3 is a semi-schematic side view of the induction cooktop on a range oven of FIG. 2, showing air flow thereabout;

FIG. 4 is a semi-schematic side view of an exemplary inverter according to an aspect of the present invention;

FIG. 5 is a semi-schematic side view of an exemplary induction cooktop (without a oven), according to a third embodiment of the present invention;

FIG. 6 is a block diagram showing a single inverter driving two coils via the use of a switching relay, according to an embodiment of the present invention;

FIG. 7 is a block diagram showing the use of a control circuit to control the operating frequencies of two inverters such that objectionable beat frequencies emanating from their associated induction coils are mitigated;

FIG. 8 is a semi-schematic top view of a cooktop having four cooking zones according to an embodiment of the present invention; and

FIG. 9 is a semi-schematic top view of one of the cooking zones of FIG. 7, showing the four induction coils thereof according to an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for enhancing the reliability and user friendliness of induction cooktops, such as those used in combination with conventional ovens, are disclosed. Reliability and user friendliness are enhanced by moving the power electronics, e.g., the inverter, away from the induction coils that are situated atop the oven. In this manner, the detrimental effects of heat rising from the oven are mitigated and noise from the power electronics fan is reduced. Further, the cooktop can be operated when the oven is in a self-cleaning cycle.

An induction cooktop, as the term is used herein, can refer to an assembly comprising one or more energizing work coils (induction coils); a top formed of glass, ceramic, or any other suitable material; thermal sensors that are used to detect the ceramic or glass top's temperature; and/or indicator lights or readouts for providing information to the operator. Moreover, as the term is used to describe embodiments of the present invention, the term does not generally include the power electronics, e.g., the inverter(s). According to one or more embodiments of the present invention, the power electronics have been separated from the remaining components of a contemporary cooktop.

More particularly, one embodiment of the present invention comprises an induction range wherein the induction coil or coils can be placed on top of a conventional, i.e., hot, cooking oven without the negative side affects created by the heat of the oven beneath it. The power electronics can be located away from the induction coils. The induction cooktop can be very thin when the power electronics are remoted in this manner.

When the power electronics are located remotely with respect to the induction coils (the power electronics are thus not located atop the conventional oven), then the induction cooktop can be used when the conventional oven is in a self-cleaning cycle without concern that heat from the conventional oven might harm the induction cooktop's power electronics. Moreover, an electric or gas range can have induction cooking elements provided on the cooktop in such a way as to substantially mitigate the concern of damage to the power electronics caused by the heat from oven below the cooktop or the heat generated during the self cleaning cycle.

According to one embodiment, the invention can comprise an electric induction generator in the form of a single ended, half bridge, or full bridge resonant circuit or some other form of electronic circuit that facilitates the generation of a magnetic field through a single or multiple coils for each inverter that is used to heat a ferrous material placed on the cooktop within the magnetic field. Typically, the cooktop will be covered with a top formed of ceramic glass or other appropriate material, upon which the ferrous cooking container is placed.

Under the cooking surface of the ceramic glass are located the induction coil or coils. The induction coils produce the magnetic field, which extends upwardly through the glass so as to heat the ferrous cooking utensils. The induction coils can be energized by electronic inverters or similar circuits. The coils for each cooking zone can be comprised of a single or multiple coils connected and configured in a way to create the desired magnetic field. Such coils may be configured in concentric circles or configured adjacent each other forming one larger coil.

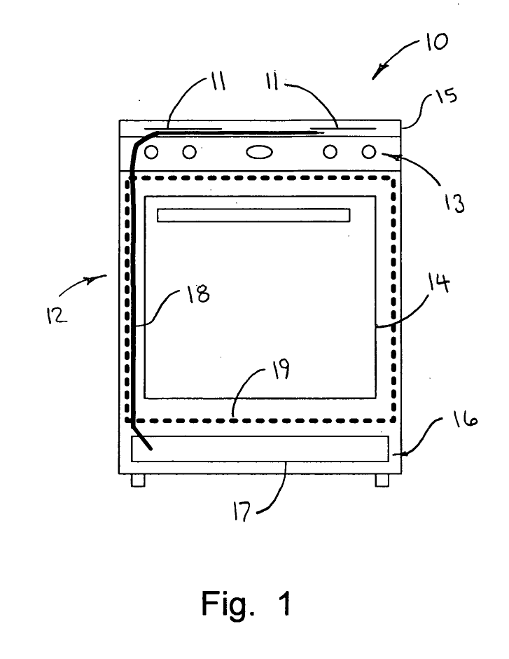

Referring now to FIG. 1, power electronics 16 can be located below an oven 12 so as to isolate power electronics 16 from heat from oven 12. In this manner, more reliable and quieter operation is achieved.

More particularly, a cooktop/oven combination or range 10 can have a cooktop 15 disposed atop oven 12. Cooktop 15 can comprise a plurality, e.g., two, three, four or more, of induction coils 11, such coils creating the desired magnetic file and configured as single coils and/or multiple coils in concentric circles or configured adjacent each other forming one larger coil. Controls 13 allow oven 12 and coils 11 to be turned on and off and the heat provided thereby to be adjusted. Oven door 14 facilitates access to oven 12. Oven 12 can be generally surrounded with thermal insulation 19 so as to help isolate power electronics 16 from heat from oven 12. Power electronics 16 can comprise one or more inverters 17 for driving coils 11. A cable 18 can connect power electronics 16 to coils 11 of cooktop 15. Cable 18 can extend under the ceramic top of cooktop 15 and can run between each inverter and its associate induction coil 11. Cable 18 is used to transfer the power from the inverter to the coils 11 and to receive sensor signals from the thermal sensors under the glass cooktop, and to provide indicator signals to the displays and indicators under the glass top to provide information to the operator.

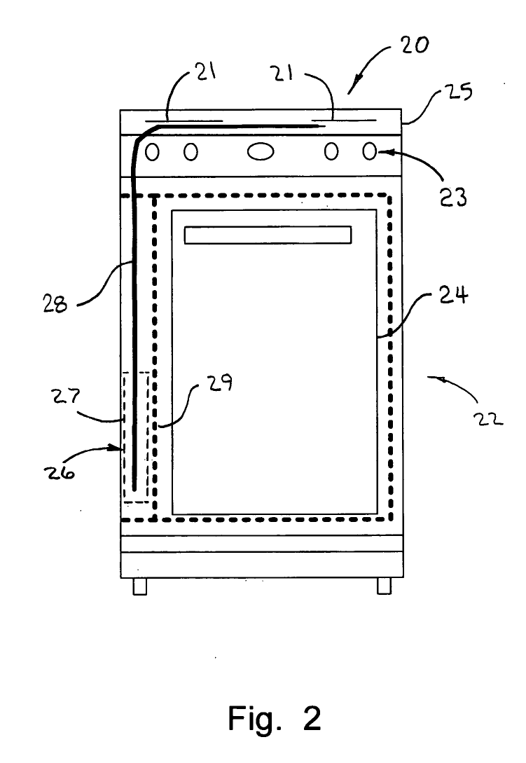

Referring now to FIG. 2, power electronics 26 can alternatively be located beside an oven 22 so as to isolate power electronics 26 from heat from oven 22. Indeed, power electronics 26 can be located at various different locations that are away from or remote with respect to cooktop 25 such that heat rising from oven 22 is less likely to adversely affect the operation of cooktop 25. In this manner, more reliable and quieter operation is achieved.

More particularly, a cooktop/oven combination or range 20 can have a cooktop 25 disposed atop oven 22. Cooktop 25 can comprise a plurality, e.g., two, three, four, or more of induction coils 21. Controls 23, which may be of rotary knob, touch controls or other control inputs, allow oven 22 and coils 21 to be turned on and off and the heat provided thereby to be adjusted. Oven door 24 facilitates access to oven 22. Oven 22 can be generally surrounded with thermal insulation 29 so as to help isolate power electronics 26 from heat from oven 22. Power electronics 26 can comprise one or more inverters 27 for driving coils 21. A cable 28 can connect power electronics 26 to coils 21 of cooktop 25. Cable 28 can extend under the ceramic top of cooktop 25 and can run between each inverter and its associate induction coil 21. Cable 28 can be hard wired or connected by quick disconnect connectors to the Power Electronics 26 allowing for ease of service.

Thus, the inverters can be placed on the lateral edges of the range, on the back of the range, or within the base of the range cabinet. They can also be placed between the floor and the bottom of the range or at any other desired location that is away from the top of the oven. For example, the inverters can also be packaged in a separate cabinet and placed in a remote location such as the back wall or an adjacent wall or cabinet. A benefit of the side and bottom mounting is that the electronic enclosures can be enclosed in a drawer that can be slid out from the range to allow maintenance or service.

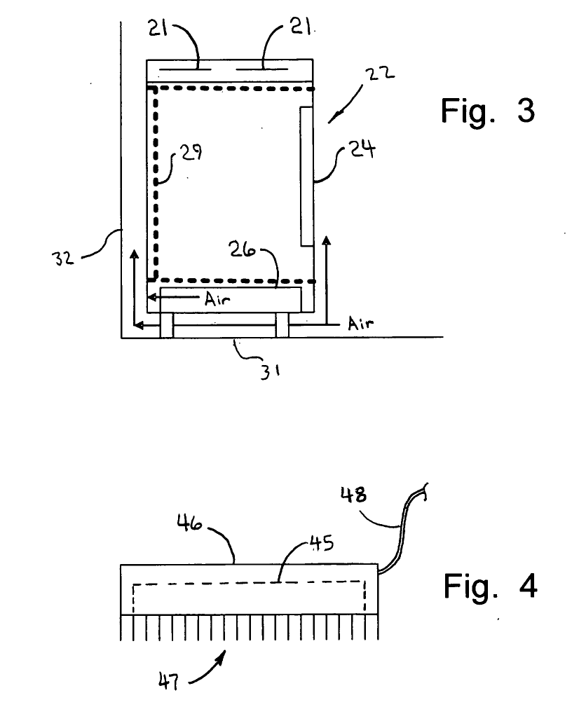

Referring now to FIG. 3, fresh air can be drawn in from the base of the range where the air is cool. The air can pass through or around the power electronics enclosure as indicated by the arrows. Floor 31 and wall 32 can help channel the air. Thus, the air can cool the electronic components, including the inverters, inside of the power electronics enclosure. Cooling surfaces, e.g., fins, of the inverters can be either internal or external with respect to the electronics enclosure.

A fan can be used to draw air in and over a cooling member, such as a heat sink. The cooling member can be an integral part of the cabinet enclosure such that the natural convection currents from the cool air on the ground level rise up around the hot oven, thus creating a circulating cooling current of air over the cooling member of the inverter enclosure.

A further advantage of one or more embodiments of the present invention is that an induction range can be operated without cooling fans. This is possible, at least in part, because moving the inverters away from the hot upper surface of the range and thermally insulating the inverters reduces their need for such cooling. The base of the inverter enclosure can be formed with cooling surfaces such that the natural convection of the air from the floor and up the back of the oven cause cooling convection currents to be moved over the cooling surface, or fins, so that the use of fan cooling is no longer necessary for cooking, at least at some power levels. Eliminating the fans allows the range to operate with substantially less noise. At those power levels where fan cooling is necessary, fans can be used.

A sensor or multiple sensors under the glass are situated for each coil to provide temperature feedback of the glass top and coil structure for enabling power control of the inverter and shutoff of the inverter based on safe operating conditions for the power electronics and the cooking surface. The combination of the thermal sensor or sensors together with present timing programs can be integrated for “intelligent cooking.”

A display comprising a single LED light or multiple digit display lights can be situated under the glass cooktop to provide the operator with information as to the cooking power level, temperature, time or fault diagnostics.

The separation of the inverters from the induction coils has the additional advantage of removing electronic circuitry from under the ceramic glass top, which if broken, could allow liquid spillage to leak into a high voltage compartment. Of course, such leakage could be very dangerous.

A safety shutoff can be configured so as to cut off all power if flooding, leakage, or a spill is detected. For example, the ranges main circuit breaker can be configured to blow when water (such as from a flood) reaches a level where contacts were shorted.

In view of the foregoing, a cooktop/oven combination can comprise an oven, an induction cooktop disposed atop the oven, and power electronics for the induction cooktop dispose remotely with respect to the induction cooktop. The power electronics can be disposed at a location where heat from the oven does not have a substantial detrimental impact thereon. The power electronics are disposed beneath the oven. The power electronics can be disposed in a drawer beneath the oven. The power electronics can be disposed beside the oven. The power electronics are not disposed between the cooktop and the oven. The power electronics can be placed under the oven cavity with insulation separating the two sections. The power electronics can be placed on one or both sides of the oven cavity with insulation separating the two sections. The power electronics can be placed on the back of the oven cavity with or without insulation separating the oven and the power electronics. The power electronics can be placed in a remote location outside of the range such as on the back or side walls or in a pedestal supporting the induction cooktop.

An induction power supply, e.g., the power electronics, can comprise a single ended circuit, a half bridge circuit or a full bridge circuit. A variety of well-known insulation materials can be used to separate the cooking sections and the power electronic sections. One or more cables can be used to connect a temperature sensor system to detect the temperature of the cooking surface or to detect the temperature of the cooking vessel.

A metal cabinet can be used as the cooling member for the induction power electronics through the use of natural convection cooling. Operation of the induction cooking range without cooling fans can be facilitated. This can be done via remoting of the power electronics with respect to the induction coils and/or via the use of less temperature sensitive components of the power electronics.

Referring now to FIG. 4, an inverter enclosure 46 can contain the inverter or invertors 45. Enclosure 46 can optionally have cooling fins 47 extending therefrom. Airflow, such as that illustrated in FIG. 3, can be used to cool the power electronics, e.g., the inverter(s) 45, contained within inverter enclosure 46.

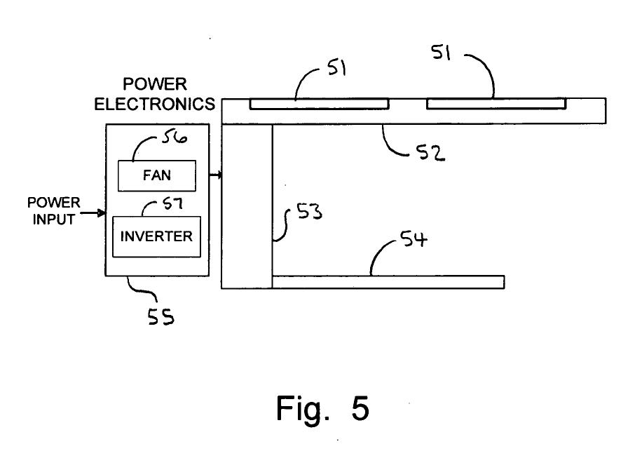

Referring now to FIG. 5, according to one embodiment of the present invention, the oven can be omitted. Enhanced operation and installation options can still be obtained even though damage to inverter 57 caused by heat from an oven is not a concern in this embodiment. Power electronics 55 can be remoted with respect to induction coils 51 so as to mitigate noise from fan 56 and so as to allow cooktop 52 to be thinner and more attractive in appearance. Noise from fan 56 is mitigated because fan 56 is moved farther away from the person operating cooktop 52. Cooktop 52 can be supported by pedestal 53. Foot or feet 52 prevent cooktop 52 from overturning.

Noise reduction of an induction range can provided through fan control. Contemporary induction ranges are configured such that the electronic circuits thereof use forced air, i.e., fan, cooling. Fan cooling generates noise from the fan itself, as well as from vibration of other parts of the range. This noise can be annoying to the consumer.

According to one or more embodiments of the present invention, induction power electronics requires less cooling than those of contemporary circuits. This can be accomplished by using less heat sensitive components, for example. Further, a time delay can be provided for the activation of the cooling fan, so that the cooling fan is not operating until it is actually needed. The use of such a time delay can substantially reduce the amount of noise caused by an induction cooktop, at least for a period of time.

Either alternatively or in addition to the time delay, activation of the cooling fan can be under the control of a thermal sensor system, such that the fan is not operated until the temperature of the invertors has reached a level where such cooling is desired. For example, the thermal sensor system can comprise one or more thermistors placed within the power electronics enclosure.

Thus, during initial cooking the fan is not activated until a pre-set time period and/or until a temperature limit within the electronic enclosure is reached. The fan can then be activated at a slow speed and the fan speed then increased as the heat inside the induction range increases. Thus, the speed of the fan can be determined by the amount of cooling that is needed by the power electronics. This increase in internal temperature can be sensed on the heat sink of the power devices, under the glass ceramic top or as an ambient senor or in any other desired location.

Regulation of the use of fans for cooling the power electrons can be based on the internal temperature of the electronics. Thus, very low fan speeds can be used at lower power cooking and the speed of the fan can be increased as the cooking power increases.

Thus, according to one embodiment the present invention comprises a method for cooling an induction range, wherein the method comprises not turning on a fan when the induction range is first turned on. The method can comprise turning on a fan after the induction range is first turned on. The method can comprise turning on a fan a pre-determined length of time after the induction range is first turned on. The method can comprise turning on a fan after a pre-determined temperature is reached by the induction range

The speed of a fan can be gradually increased after an induction range is turned on. The speed of the fan can be dependent upon a temperature of the power electronics and can be proportional to this temperature.

According to one embodiment, the present invention can comprise power electronics that do not require fan cooling, such as due to the use of high efficiency electronic circuits design and/or convection cooling.

According to one embodiment of the present invention, a single LED indicator lamp can be used for each induction cooking element or other type heating element. In this manner, information regarding the operation of the induction cooktop can be provided to the operator simply by turning the LED on or off or changing the color of the LED display light. According to one embodiment of the present invention, information codes are provided by the LED by turning it on and off according to a predetermined sequence. Changing colors can also be used. Thus, the number of times the LED is illuminated determines the particular code being communicated or a certain color will give a predetermined error code. For example, an error code for internal ambient over-temperature can be communicated by eight consecutive quick flashes of the LED separated by a short pause and then repeating the sequence of eight consecutive quick flashes repeatedly. Failure of the power device with in the inverter may be signaled by a red flashing light—indicating the need to call a service agent.

Thus, a single lamp can be used for diagnostic information with induction cooking ranges or radiant cooking ranges. A pre-defined code system using a blinking light can provide useful diagnostic information.

Contemporary induction cooktops start up using anywhere from low power to high power, depending upon how the power control is set. Then the operator must adjust cooking power to a desired level. This creates the need for repetitive re-adjustment of the induction cooktop in order to find the correct cooking power level.

According to one embodiment of the present invention, software or another mechanism of the induction range is configured such that the induction cooktop stores the last power or temperature setting (such as when being turned off) and then when the induction cooktop is turned on again, it will start at the same power or temperature control level. This reduces the time to set up the correct power level each time when the cooktop is started.

Thus, according to one embodiment of the present invention, power and/or temperature of the induction cooking range is controlled so as to enable the range to return to a preset level.

According to one embodiment of the present invention, the induction cooktop can be configured to have a frequency control that eliminates a beat frequency or interference frequency between two or more pans. In this manner, two or more induction coils can be operated simultaneously without creating undesirable interference frequency between the elements.

As those skilled in the art will appreciate, each of the induction coils of particular contemporary induction cooktop operate within similar frequency ranges. Each pan has a unique response to the induction inverter and thus the resonant frequency changes. When two pans are cooking next to each other, or in close proximity to each other, the difference in their resonant or operating frequencies creates a noise in the audible spectrum that can be heard by the operator. This noise is often annoying.

According to one embodiment of the present invention, an induction range can have multiple induction coils that can be operated simultaneously without the annoying beat frequency created between two pans. Any desired number of induction coils can be configured to operate in this manner.

An electric induction generator can comprise a single ended, half bridge or full bridge resonant circuit or some other electronic circuit that generates a magnetic field that is used to heat a ferrous material placed on the cooktop within the magnetic field. Typically, the cooktop will be covered with a ceramic glass top on which the ferrous cooking container is placed. Under the cooking surface, typically ceramic glass, can be located the induction coils. The induction coils produce the magnetic field upward through the glass to heat the ferrous cooking utensils.

The induction coils can be energized by the electronic inverters or similar circuits. The operating frequencies of each inverter can be controlled by one master microprocessor. This microprocessor can determine the operating frequency range of each inverter. The frequency range is set so that the lower frequency end of one inverter is 15 KHz (or some other frequency range above the audible hearing range) above the high operating end of the second inverter. That is, the difference in frequencies between inverters can greater than the highest audible frequency such that beat frequencies cannot be heard. To accomplish this several approaches to inverter design may be taken.

For example, combination of a half bridge and full bridge inverters can be utilized. The half bridge inverter can operate at a substantially higher frequency range than the full bridge or vise versa. That is, two different types of induction power systems can be used to mitigate undesirable beat frequencies.

As a further example, an offset of frequencies from the same topology inverter, such as a full bridge inverter operating at a frequency range of 24 kHz to 65 kHz. The first inverter would operate from 24-45 kHz and the second inverter would operate from 50 to 65 kHz. Alternatively, such offset frequencies can be from invertors having different topologies.

To achieve low end power control, duty cycle control is used from the lowest continuous power setting available based on each pan type. To overcome the obstacle that one element must run at very high power and the second element must run at very low power in order to have a suitable frequency spread between the elements, a half bridge inverter can be paired with a full bridge inverter. The half bridge inverter operates at a higher resonant frequency for full power than the full bridge. This allows a greater range of performance for the induction heating elements.

Thus, an induction range can eliminate the noise between cooking elements by controlling the operating frequency of each cooking element so as to insuring that the operating frequencies are separated by 15 kHz or another appropriate frequency range that can not be heard. Different circuit topologies, such as a full bridge and a half bridge, or a single ended with a half, bridge or other combinations, can be used such that the resonant operating frequency between each element is separated by more that 15 kHz.

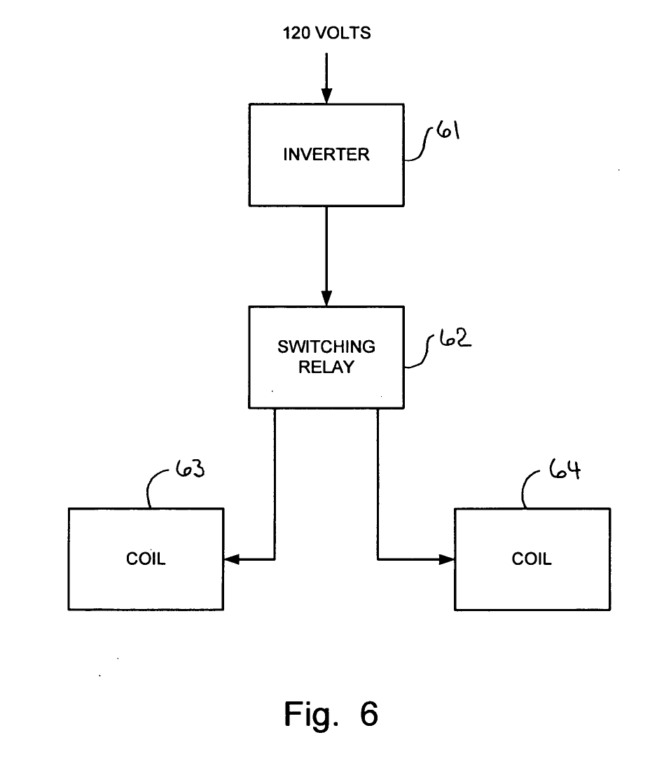

Referring now to FIG. 6, according to one embodiment of the present invention one power inverter 61, operating at 120 volts for example, drives two or more coils 63 and 64 through the use of a switching relay 62 or other electronic means. Switching relay 62 can switch between coils 63 and 64 such that only a selected one of coils 63 and 64 is operating and is thus capable of cooking. Alternatively, switching relay 62 can switch more rapidly between coils 63 and 64 such that both coils 63 and 64 are effectively energized and such that simultaneous cooking upon both coils 63 and 64 is facilitated.

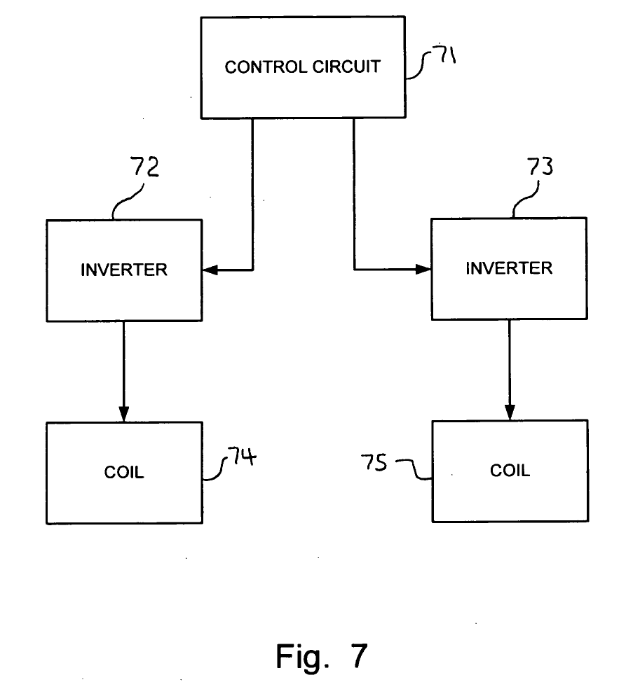

Referring now to FIG. 7, a microprocessor or control circuit 71 controls the operating frequency of two inverters 72 and 73, so as to substantially mitigate objectionable, audible beat frequencies at coils 74 and 75, as describe above. Control circuit 71 can similarly control the operating frequency of more than two inverters so as to mitigate beat frequencies from their associated induction coils.

In cooking in commercial operations and particularly fast food operations, orders are often cooked one after the other, sometimes with a delay of a minute or two between orders. Typically, in many restaurant kitchens a meal is cooked in a pan and when the food is finished the food is put on the plate and the pan wiped clean and put back on the burner. The pan gets hot and is ready for the next order. Or a new clean pan is put on the burner and gets hot and is ready for the next order.

Preheating the pan speeds up the cooking. The challenge with the induction cooking is that when an empty pan is put back on the cooking surface, the power to the pan is such that the pan heats rapidly when empty and the non-stick or other coating surface may burn from the high heat.

According to one embodiment of the present invention, a series of logic steps prevents the pan from burning and at the same time keeps the pan preheated for the next batch of cooking.

For example, the following logic may be used:

1. The pan is put on the cooktop with or without food and the desired power level set for cooking the food.

2. When the food is finished cooking, the pan is removed from the cooktop and the food placed on a plate or other utensil.

3. When the pan is removed from the cooktop, the internal logic automatically senses the removal of the pan and reduces the power to a predetermined “holding” level. This level will keep the pan warm but not so hot as to burn the food.

4. The cook can then put an empty pan back on the cooktop and leave it there without worry of burning the non stick or other coating on the pan.

5. When the next meal is ready to cook, the food is put into the pan and the cook presses a “cook” button that tells the logic to return the power to the original pre-set cooking power level.

6. The cycle is then repeated when the pan is removed.

According to one variation on the logic describe above, the cook can push a button that says “Hold”. This would then return the power to a holding level. The challenge here is that if he forgets, the coating on the pan may burn. Consequently, for some operations the automatic return to the holding temperature may be desired.

According to another variation on the logic describe above, a temperature control function could be used where the cooking temperature is set. A second “high point” temperature level is set so that the cooktop will regulate the temperature of the pan so the pan temperature can not reach the level that can burn the non-stick coating. This requires accurate sensing of the pan and adjustments for when the pan is cold or the glass is hot and a cold pan is put on. A timer function can also be utilized to regulate the warming or heating function or to reactivate the previous heating level.

Control of the cooking control system can be effected through software to provide intelligent control of the power to the cooking utensil. Control of the cooking control system can enable the induction range to go into a holding power or temperature level to keep a pan preheated for fast heat up and increased cooking productivity. Control of the cooking system can be effected by using a switch to toggle from the desired cooking power to a holding power or temperature level. The holding level may be set by the use of a thermistor or through predetermined testing of power level points.

One full-bridge or half-bridge inverter can be configured to operate two or more separate work coils. The power of the inverter can be shared through logic control to the two inverters. A relay or other electronic switching mechanism or circuit is used to switch the power between the plurality of coils in a pattern sufficient to generate the selected power level for each inverter.

In one or more embodiments of the present invention, the oven can be a conventional oven, a convection oven a microwave oven, a turbo chef oven, and/or any variation of such ovens.

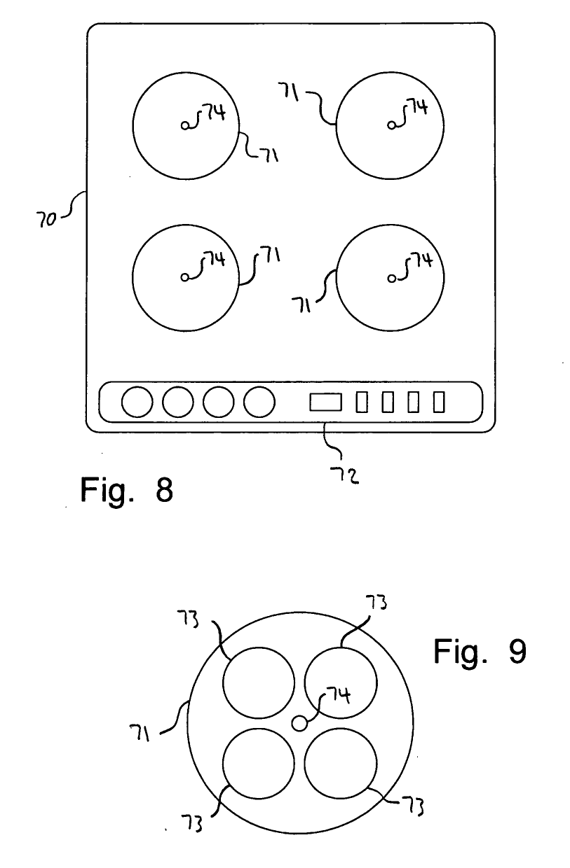

Referring now to FIG. 8, according to an embodiment of the present invention a cooktop 70 can have one or more cook zones 71. Cook top 70 can have one, two, three, four, or more cook zones 71. Each cook zone 71 is a place on cooktop 70 where a pot or other cooking utensil can be placed for cooking. As discussed below, each cook zone 71 can comprise any desired number of induction coils.

A thermistor 74 can be located proximate or within each cook zone 71. For example, a thermistor 74 can be located proximate the center of each cook zone 71, as shown.

Cooktop 70 can also comprise a control and display panel 72. Control and display panel 72 can comprise a plurality of controls for controlling the amount of heat at each cook zone 71 and for indicating how hot each cook zone 71 is, for example. Control and display panel 72 can comprise other items, such as a clock and/or timer.

Referring now to FIG. 9, an exemplary cook zone 71 can comprise four induction coils 73. Cook zone 71 can comprises any desired number of induction coils in any desired configuration. For example, cook zone 71 can comprise one, two, three, four, or more induction coil 73. Induction coils 73 can be arranged concentrically, side-by-side, or any desired combination of concentrically and side-by-side. Induction coils 71 can be arranged any desired pattern. Each induction coil 73 can have any desired shape, and thus need not be round. Thus, each induction coil 73 can be round, oval, oblong, square, rectangular, triangular, or have any other shape.

A thermistor 74 can be located proximate or within each induction coil 73. Thermistor 74 can be used to measure the temperature of cook zone 71 for use in automated control of the heat provided thereby and/or for display on display panel 72.

One or more embodiments of the present invention mitigate heat damage for a cooktop that is used in combination with a conventional oven. According to one or more embodiments, noise is reduced. Thus, a substantially more reliable, less costly, and user friendly induction cooktop/range can be made. In one or more embodiments of the present invention, the oven can be a conventional oven, a convection oven a microwave oven, a turbo chef oven, and/or any variation of such ovens.

Embodiments described above illustrate, but do not limit, the invention. It should also be understood that numerous modifications and variations are possible in accordance with the principles of the present invention. Accordingly, the scope of the invention is defined only by the following claims.

1. A cooktop/oven combination comprising an oven, an induction cooktop disposed atop the oven, and power electronics for the induction cooktop dispose remotely with respect to the induction cooktop.

2. The cooktop/oven combination as recited in claim 1, wherein the induction cooktop comprises at least one induction coil for each cooking zone, a thermal sensor for each cooking zone, and a visual display for providing information to an operator.

3. The cooktop/oven combination as recited in claim 1, wherein the cooktop/oven combination defines a range.

4. The cooktop/oven combination as recited in claim 1, wherein the power electronics comprise at least one inverter.

5. The cooktop/oven combination as recited in claim 1, wherein the power electronics comprise at least one of a single ended circuit, a half bridge circuit, and a full bridge circuit.

6. The cooktop/oven combination as recited in claim 1, wherein the power electronics are disposed at a location where heat from the oven does not have a substantial detrimental impact thereon.

7. The cooktop/oven combination as recited in claim 1, wherein the power electronics are not disposed between the cooktop and the oven.

8. The cooktop/oven combination as recited in claim 1, wherein the power electronics are disposed beneath the oven.

9. The cooktop/oven combination as recited in claim 1, wherein the power electronics are disposed beside the oven.

10. The cooktop/oven combination as recited in claim 1, further comprising thermal insulation disposed between the oven and the power electronics so as to mitigate heat flow from the oven to the power electronics.

11. A cooktop comprised of a plurality of induction coils for each cooking zone, energized by the power inverter.

12. A cooktop comprised of multiple coils for each cooking zone and an inverter, the coils being configured in at least one of a concentric circular pattern or a non-concentric pattern, wherein the multiples coils are powered by the same inverter.

13. A method for cooling an induction cooker, the method comprising not turning on a fan when the induction range is first turned on.

14. The method as recited in claim 13, wherein the fan is turned on after a predetermined amount of time.

15. The method as recited in claim 13, wherein the fan is turned on after the power electronics has reached a predetermined temperature.

16. The method as recited in claims 13, wherein the speed of the fan is increased over time.

17. The method as recited in claim 13, wherein the speed of the fan increases with increasing temperature of the power electronics.

18. A method for operating an induction cooker that has a plurality of induction elements, the method comprising controlling the operating frequency of each induction element such that the cooking frequencies are separated by an amount that substantially mitigates audible beat frequencies.

19. The method as recited in claim 18, wherein the cooking frequencies are separated by a frequency range that is inaudible to humans.

20. The method as recited in claim 18, wherein at least two different circuit topologies of power electronics are used to energize induction elements.

21. The method as recited in claim 18, wherein at least two different circuit topologies of power electronics are used to energize induction elements, the circuit topologies comprising a single ended circuit, a half bridge circuit, and a full bridge circuit.

22. An induction cooker comprising:
at least two induction elements; and
a single inverter providing electrical power to two of the induction elements.

23. The induction cooker as recited in claim 22, wherein the inverter operates on a 120 volt input.

24. The induction cooker as recited in claim 22, further comprising a switching relay configured to switch power between two induction elements so as to facilitate cooking on either induction element.

25. The induction cooker as recited in claim 22, further comprising a switching relay configured to switch power between two induction elements so as to facilitate simultaneous cooking on two induction elements.

26. An induction cooker comprising at least one of:
an indicator light that is configured to flash on and off in a preset pattern to indicate particular fault codes; and
an indicator light that changes colors to indicate a particular fault code.
